(19) United States
(12) Patent Application Publication
(10) Pub. No.: US 2017/0091863 A1
(43) Pub. Date: Mar. 30, 2017

(54) METHODS, SYSTEMS AND COMPONENTS FOR INTEGRATING PURCHASE AND SALE OF MUTUAL FUND UNITS WITH DEALER EQUITY ORDER MANAGEMENT SYSTEMS

(71) Applicant: INVESCO CANADA LTD., TORONTO (CA)

(72) Inventors: JAMES RUSSELL, BURLINGTON (CA); HILARIO SALCEDA, RICHMOND HILL (CA); PETER INTRALIGI, RICHMOND HILL (CA); REBECCA LIU, TORONTO (CA); SARAH ORR, TORONTO (CA)

(21) Appl. No.: 15/278,695

(22) Filed: Sep. 28, 2016

(30) Foreign Application Priority Data
Sep. 28, 2015 (CA) 2905634

(51) Int. Cl. G06Q 40/04

(52) U.S. Cl. CPC G06Q 40/04

(57) ABSTRACT

Computer implemented methods and systems provide order processing and settlement of non-exchange traded mutual funds at end of day net asset value (NAV) unit prices for dealer order management systems configured to transact exchange traded securities including exchange traded funds (ETFs). Dealer order management systems may route orders to respective market computer systems and settle orders for either non-exchange traded mutual funds or exchange trade securities through the same custodial settlement computer systems previously configured only to settle orders for exchange trade securities. Dealer investment advisors (IAs) may place orders on behalf discretionary or non-discretionary clients.

### FIELD

The present disclosure relates generally to computer systems and components for the purchase and sale of exchange traded investments such as securities (e.g. conventional shares of common stocks) and shares of Exchange Traded Funds (ETFs). In particular, the present disclosure relates to methods, systems and components for integrating the purchase and sale of mutual fund securities (units) with dealer equity order management systems.

### BACKGROUND

Among the many available types of investments are exchange traded investments such as conventional shares of common stock and shares of ETFs. These investments are listed on a particular exchange and traded at market prices, determined by supply and demand. Exchanges typically operate on their respective business days between set hours (market open and close times) to perform intra-day trades at market prices. The purchase and sale of such exchange traded investments is typically performed via investment dealers, often a company or other entity employing one or more investment advisors (IAs). IAs may have discretionary clients where an IA is given authority to exercise the IAs discretion in the execution of certain orders and non-discretionary clients where authority or power is not given to the IA to act unilaterally. Investment dealers employ dealer order management systems (OMSs) to place orders as well as portfolio management tools, particularly for IAs to manage discretionary client portfolios. Within the investment dealer (or other similar entity) separate order entry mechanisms for discretionary and non-discretionary (also referred to as non-managed) clients may be maintained. As well, individual client accounts are maintained for each client. An order for a particular investment, such as the purchase of a certain number of shares of common stock, may be placed via the dealer OMS to fill requests for more than one client and/or on behalf of the account of the investment dealer/IA. That is, orders need not be individualized for each client. When an order is entered such as by or on behalf of an IA, the dealer OMS routes the order to an applicable external computer system to have the order filled by the applicable exchange. Once filled, in accordance with applicable regulations and conventions, a settlement process is undertaken with various settlement and depository systems so that the transaction is completed within a preset period of time (e.g. within 3 days).

Another type of investment available is a mutual fund (MF) operated by an entity (e.g. a mutual fund company (MFC) or sometimes referenced as a fund manufacturer) that is in the business of investing in securities and/or other assets. A MFC may establish a mutual fund and purchase a variety of securities and/or other assets to be held by the fund. The MFC then sells units (shares) of the fund (i.e. not the securities or assets themselves) to investors. The value of a unit is determined by the net asset value (NAV) of the fund (i.e. the total asset value of the fund less liabilities on a per outstanding unit basis). The NAV for a particular fund is usually calculated once at the end of a day, after market closing using closing share prices. Orders received during a trading day are filled overnight at NAV rather than at market prices during the day. The purchase and sale of mutual fund units is executed though a computer system separate from exchange traded securities. Such trades are individualized by client. There is no link between the mutual fund system and the dealer's shareholder/client accounting system which maintains records for exchange traded securities.

### SUMMARY

Computer implemented methods and systems provide order processing and settlement of non-exchange traded mutual funds at end of day net asset value (NAV) unit prices for dealer order management systems configured to transact exchange traded securities including exchange traded funds (ETFs). Dealer order management systems may route orders to respective market computer systems and settle orders for either non-exchange traded mutual funds or exchange trade securities through the same custodial settlement computer systems previously configured only to settle orders for exchange trade securities. Dealer investment advisors (IAs) may place orders on behalf discretionary or non-discretionary clients.

In one aspect there is provided a method of processing orders for non-exchange traded mutual funds within a computer implemented order management system (OMS) of a dealer. The method comprises:

receiving a mutual fund (MF) units order for a non-exchange traded MF at a dealer OMS where the dealer OMS is further configured to process orders for exchange traded securities including exchange traded funds (ETFs) at intra-day market prices;

routing the order by the dealer OMS to an applicable MF OMS configured to fulfill the order, the order comprising a routing code identifying the applicable MF OMS with which to route the order;

maintaining the order within the dealer OMS after a close of market to await fulfillment of the order at a net asset value (NAV) unit price determined for the non-exchange traded MF after the close of market; and

receiving at the dealer OMS fulfillment of the order from the MF OMS at the NAV unit price.

The method may comprises settling payment for the order electronically via a computing component of custodial settlement service system. The custodial settlement service system may be further configured to settle payment for exchange traded securities including ETFs. The method may comprise communicating a Receive Versus Payment (RVP) message for the order comprising a purchase of MF units or communicating a Delivery Versus Payment (DVP) for the order comprising a redemption of MF units.

The order may comprise one of: a discretionary client order associated with a client of the dealer having given a discretionary power to the dealer to make trades for the client at the dealer's discretion; and a non-discretionary order associated with a client of the dealer requiring the dealer to obtain the client's confirmation for trades made for the client.

The method may comprise communicating order fulfillment to a computing component of a dealer account system maintaining accounts for clients of the dealer, the computing component further configured to maintain client account information in relation to exchange traded securities including ETFs and non-exchange traded MFs traded by the client.

The method may comprise receiving the order at the dealer OMS from an order entry computer system of the dealer, the order entry computer system configured to communicate orders for exchange traded securities including ETFs and non-exchange traded MFs, the order entry system associating each order with a respective routing code with which to route the order for fulfillment. The order entry computer system may be configured to communicate orders comprising at least one of a discretionary client order associated with a client of the dealer having given a discretionary power to the dealer to make trades for the client at the dealer's discretion; and a non-discretionary order associated with a client of the dealer requiring the dealer to obtain the client's confirmation for trades made for the client.

In one aspect there is provided a computer component to process orders for non-exchange traded mutual funds by a computer implemented dealer order management system (OMS) of a dealer. The computer component may comprise at least one programmable processor and a storage device storing instructions and data which when executed by the at least one programmable processor configure the computer component to:

receive a mutual fund (MF) units order for a non-exchange traded MF at the dealer OMS where the dealer OMS is further configured to process orders for exchange traded securities including exchange traded funds (ETFs) at intra-day market prices;

route the order to an applicable MF OMS configured to fulfill the order, the order comprising a routing code identifying the applicable MF OMS with which to route the order;

maintain the order within the dealer OMS past a close of market to await fulfillment of the order at a net asset value (NAV) price determined for the non-exchange traded MF after the close of market; and

receive fulfillment of the order from the MF OMS at the NAV price.

In one aspect there is provided a method to process orders of mutual fund (MF) units for a non-exchange traded MF within a computer implemented order management system (OMS) of a MF. The method may comprise:

receiving, from a dealer OMS at a computing component of a MF OMS, a plurality of mutual fund (MF) units orders for at least one non-exchange traded MF;

maintaining the plurality of orders within the MF OMS, after a close of market to await determination of applicable net asset value (NAV) unit prices determined for each of the at least one non-exchange traded MF after the close of market;

communicating a first batch of the plurality of orders to a MF system configured to process the orders for fulfillment at the applicable NAV unit prices;

receiving the applicable NAV unit prices after close of market from the MF system;

associating the applicable NAV unit prices with each respective order of the plurality of orders; and

communicating a second batch of the plurality of orders to the MF system to process the orders for fulfillment, the second batch of the plurality of orders including the applicable NAV unit prices.

The method may comprise communicating fulfillment of the order at the NAV unit price to the dealer OMS. Each order may be associated with a time of receipt, timestamp by the MF OMS to determine which orders receive a current day NAV unit price by the MF system when the orders are received before a close of market time and which orders receive a next day NAV unit price.

The dealer OMS may be further configured to process orders for exchange traded securities including exchange traded funds (ETFs) at intra-day market prices.

In one aspect there is provided a computer component to process orders for non-exchange traded mutual funds by a computer implemented mutual fund (MF) order management system (OMS). The computer component may comprise at least one programmable processor and a storage device storing instructions and data which when executed by the at least one programmable processor configure the computer component to:

receive, from a dealer OMS at a computing component of a MF OMS, a plurality of mutual fund (MF) units orders for at least one non-exchange traded MF;

maintain the plurality of orders within the MF OMS after a close of market to await determination of applicable net asset value (NAV) unit prices determined for each of the at least one non-exchange traded MF after the close of market;

communicate a first batch of the plurality of orders to a MF system configured to process the orders for fulfillment at the applicable NAV unit prices;

receive the applicable NAV unit prices after close of market from the MF system;

associate the applicable NAV unit prices with each respective order of the plurality of orders; and

communicate a second batch of the plurality of orders to the MF system to process the orders for fulfillment, the second batch of the plurality of orders including the applicable NAV unit prices

In one aspect there is provided a method to process orders for mutual fund (MF) units for a non-exchange traded MF by a computer implemented MF system comprising at least one computer component configured to process MF orders, maintain records and perform fund accounting for at least one non-exchange traded MF. The method may comprise:

receiving first orders for MF units of at least one non-exchange traded MF from a first channel comprising computing components configured to trade and settle exchange traded securities and non-exchange traded MFs;

receiving second orders for MF units of at least one non-exchange traded MF from a second channel comprising computing components configured to trade and settle only non-exchange traded MFs;

processing the first orders and second orders at respective net asset value (NAV) unit prices determined after a close of market for each of the at least one non-exchange traded MF; and

communicating the respective NAV unit prices back to the first channel and second channel.

The method may comprise settling payment of at least some of the first orders via the first channel and settling payment of at least some the second orders via the second channel.

The method may comprise maintaining information and preferences for respective dealers to configure steps of processing and settling in respect of first orders received via the first channel from the respective dealers.

The method may comprise communicating with a transfer agent and registrar system of the first channel to issue or cancel MF units in accordance with the first orders as processed, wherein the transfer agent and registrar system is configured to communicate issuances and cancellations of MF units in accordance with the first orders as processed with a depository system of the first channel providing custodial settlement services.

The method may comprise communicating payment and processed order communications with the first channel to settle payment for the first orders through the depository system and in accordance the issuances and cancellations of MF units by the transfer agent and registrar system.

The payment and processed order communications may be communicated with a settlement agent system having an account with the depository system, the settlement agent concluding settlement on behalf of the MF system in accordance the issuances and cancellations of MF units by the transfer agent and registrar system.

The method of may comprise:

preparing reconciliation reports from transaction records prepared during the processing of the first orders as processed;

presenting the reconciliation reports and transaction records for verification of accuracy; and,

presenting a user interface to receive input to review and correct the transaction records.

The method may comprise settling payment of at least some of the first orders via the first channel including generating one or more output files for communication via the first channel in furtherance of settlement using the records as corrected.

First orders may be received from at least one MF order management system (OMS) configured to receive orders for non-exchange traded MF units within the first channel. The first orders may be received with a time of receipt timestamp associated by the at least one MF OMS. First orders may be processed by the MF system to receive a current days NAV unit price if received before market close in accordance with the timestamp. Receiving the first orders may comprise: receiving a first batch file of first orders after market close from each of the at least one MF OMS, the first orders received before association with a NAV unit price by the at least one MF OMS; and, subsequent to the communicating of the respective NAV unit prices back to the first channel to deliver the NAV units prices to the at least one MF OMS, receiving a second batch file that includes the first orders of the first batch file, wherein the first orders are associated with the respective NAV unit prices by the at least one MF OMS. The step of processing the first orders at NAV unit prices may comprise using the NAV unit prices as received in the second batch file.

The method may comprise pre-processing the first orders to load the first orders into a computing component of a order processing and record system to process the first orders with the second orders to leverage operations of the order processing and record system for orders received from both of the first and second channels.

Each of the first orders may be placed by dealers on behalf of clients of the dealers and each of the first orders may include only dealer information to process the first orders, such that the respective MF units of the first orders are processed as owned by the respective dealers and wherein each of the second orders include client information for individual clients to process the second orders, such that the respective MF units of the second orders are processed as owned by the respective individual clients.

In one aspect there is provided a computer implemented MF system comprising at least one computer component configured to process orders for mutual fund (MF) units for a non-exchange traded MF. The computer component may comprise at least one programmable processor and a storage device storing instructions and data which when executed by the at least one programmable processor configure the computer component to:

receive first orders for MF units of at least one non-exchange traded MF from a first channel comprising computing components configured to trade and settle exchange traded securities and non-exchange traded MFs;

receive second orders for MF units of at least one non-exchange traded MF from a second channel comprising computing components configured to trade and settle only non-exchange traded MFs;

process the first orders and second orders at respective net asset value (NAV) unit prices determined after a close of market for each of the at least one non-exchange traded MF; communicate the respective NAV unit prices back to the first channel and second channel; and

settle payment of at least some of the first orders via the first channel and settling payment of at least some the second orders via the second channel.

These and other aspects will be apparent to a person of ordinary skill in the art.

### BRIEF DESCRIPTION OF THE DRAWINGS

For a better understanding of embodiments of the systems, methods and devices described herein, and to show more clearly how they may be carried into effect, reference will be made, by way of example, to the accompanying drawings in which:

FIG. 1 is an illustration of a computer system for the purchase and sale of equities and mutual fund units in accordance with one embodiment;

FIG. 2 is an illustration of a portion of the computer system of FIG. 1, showing a component thereof (a MF computer system) in more detail and in accordance with one embodiment;

FIG. 3 is an illustration of a flow of operations between components of FIG. 2 for order processing for the purchase and sale of MF units in accordance with one embodiment;

FIGS. 4A-4C and 5A-5E are flowcharts for operations of certain components of the computer system of FIG. 1 in furtherance of the settlement of orders for MF units in accordance with one embodiment; and,

FIG. 6 is an illustration of a portion of the computer system of FIG. 1, showing components thereof (an MF order management system and a MF computer system) in more detail and in accordance with one embodiment.

It will be appreciated that for simplicity and clarity of illustration, not all elements are shown in the figures. For example, various computer network infrastructure and details of particular components are omitted.

### DESCRIPTION

Computer implemented methods and systems provide order processing and settlement of non-exchange traded mutual funds at end of day net asset value (NAV) unit prices for dealer order management systems configured to transact exchange traded securities including exchange traded funds (ETFs). Dealer order management systems may route orders to respective market computer systems and settle orders for either non-exchange traded mutual funds or exchange trade securities through the same custodial settlement computer systems previously configured only to settle orders for exchange trade securities. Dealer investment advisors (IAs) may place orders on behalf discretionary or non-discretionary clients.

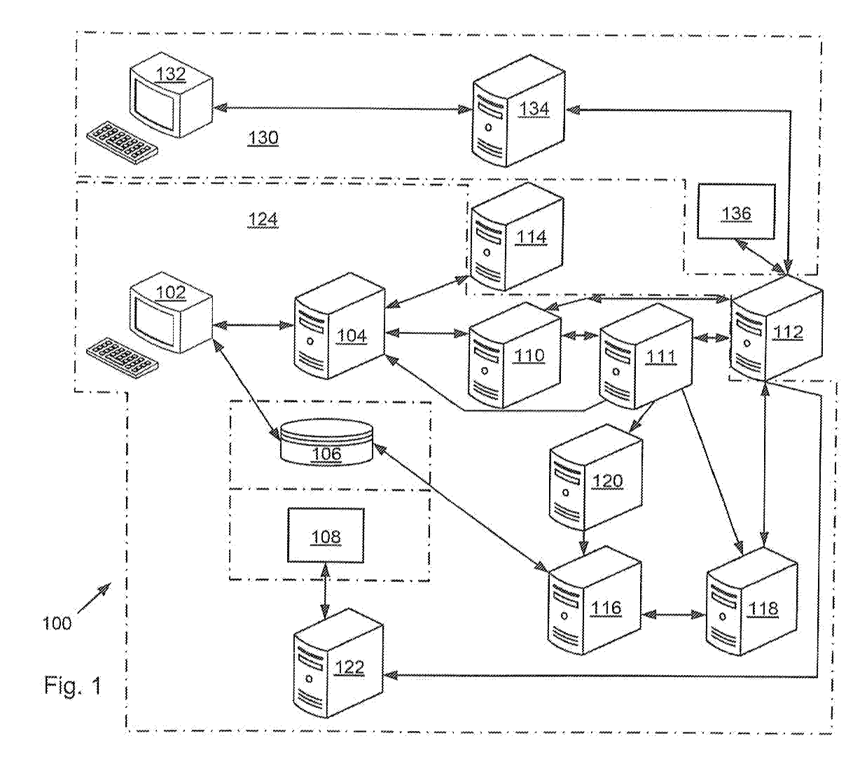

FIG. 1 is an illustration of a simplified computer system 100 for the purchase and sale of equities and MF units in accordance with one embodiment. Broadly speaking, computer system 100 comprises three main groups of components—dealer-side components, intermediary components (e.g. for custodial settlement services) and market-side components. Computer system 100 is configured to integrate the purchase and sale of MF units into previously known and used components and operations for the purchase and sale of exchange traded securities, obviating (or at least minimizing) the need for a separate channel of components and operations.

It is understood that the term “component” used herein may include, but is not limited to one or more computers such as servers, desktops, laptops, workstations, terminals, tablets, smartphones, or systems equivalent thereto configured for communication. Communication and/or data transmission between the various computers is accomplished over one or more networks consisting of electronic devices connected either physically or wirelessly. Exemplary networks include public and/or private networks, including but not limited to a Local Area Network, a Wide Area Network, an organizational intranet, the Internet, or networks equivalent thereto. Each computer component may comprise at least one processors (e.g. programmable by instructions and data/software), include one or more types of memory and may comprise or be connected to data storage devices, including external databases for example. Each computer may comprise or interface to a display device (e.g. a computer monitor, TV, LCD or other display screen, either with or without touch functionality, etc.) as well a one or more I/O devices (e.g. keyboard, mouse, pointer device, speaker, microphone, printer, etc.) for operation of the computer.

The software may be stored in a computer program product (i.e. a device storing in a non-transient manner) and loaded into a component computer using a removable storage drive, interface, hard drive, communications interface, or equivalents thereof. The control logic (software), when executed by the processor, causes the processor to perform the functions and methods described herein. In another embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

In FIG. 1 there is shown a dealer order entry component 102, a dealer OMS 104, a dealer accounting and records system 106 and a security master 108. It is understood that within a dealer environment, more than one dealer order entry component 102 may be maintained. For example separate dealer order entry components may be maintained for discretionary and non-discretionary client orders. The discretionary client order system may receive orders for respective discretionary client accounts. Though referenced as a dealer order entry component, component 102 may provide further functionality to including portfolio management functions to IAs. Such portfolio management functions may be configured to enable an IA or more than one IA at the dealer to aggregate trade orders from multiple clients. For example, a trade order for 200 MF units of a particular MF may be aggregated with another order for 300 units of the same particular fund such that a single order for 500 units is ultimately placed and communicated to a component of system 100 for processing the purchase for the dealer.

Dealer OMS 104 receives orders and routes same for fulfillment by the applicable external computer system as discussed below. Dealer accounting and records system 106 maintains client accounts for discretionary and non-discretionary clients, average price accounts (for determining trade prices for discretionary clients and advisors, etc.) and other records. Fill messages for particular orders are received from dealer order entry component 102. System 106 operates to settle and reconcile such orders with the intermediary components as discussed below. Security master 108 comprises configuration data for the processing and settling of such orders as described further below.

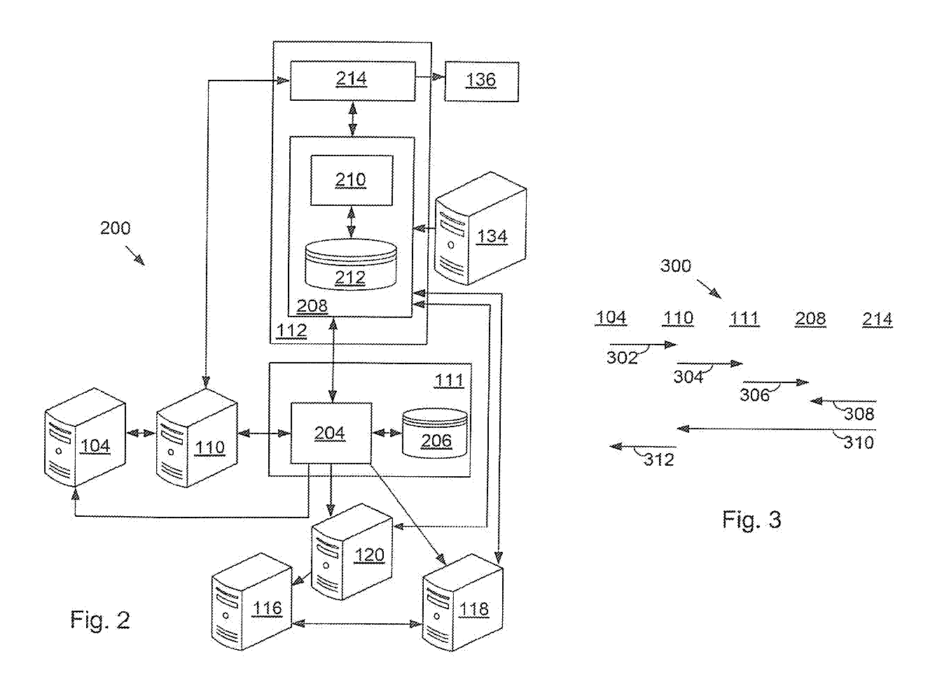

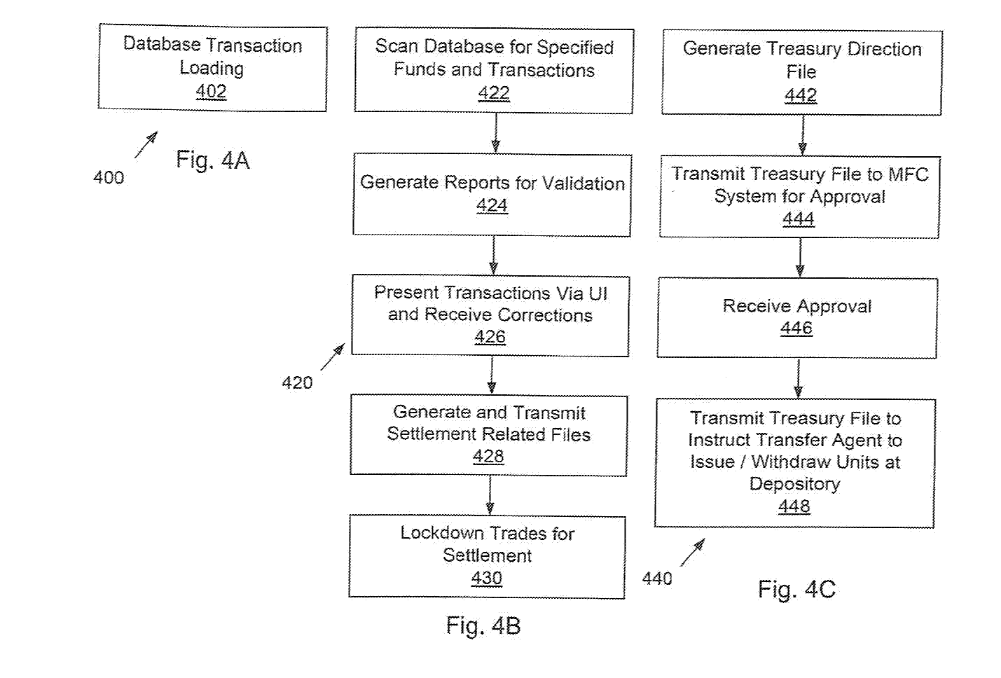

As noted dealer OMS 104 routes orders to external computer systems for order fulfillment. For clarity, two external systems are shown. One external system is MF OMS 110 for the purchase and sale of MF units from a MF system 112 via MF order pre-processing component 111. MF order pre-processing component 111 and MF system 112 are described in further detail below with references to FIGS. 2 and 3. The second external system is exchange traded security OMS 114 for the purchase and sale of exchange traded securities from a particular exchange or market provided by exchange traded security OMS 114.

Computer system 100 further includes intermediary components such as for custodial settlement, including depository system 116, settlement agent system 118 and transfer agent and registrar services system 120. Also shown is third party component 122 which delivers price data between MF system 112 and security master 108 used for position valuation for holdings (MF units held) at the dealer, among other things.

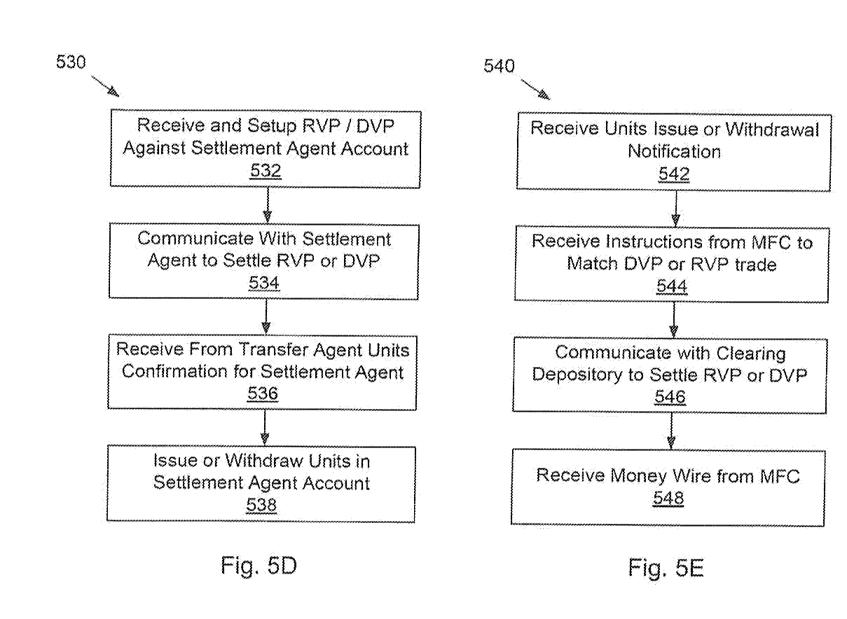

In brief, the intermediary components (116, 118 and 120) perform operations such as but not limited to: treasury related services to create and/or cancel to MF units in the marketplace; payment related services to flow payments between the dealer and the MFC in settlement of the respective purchases/subscriptions or sales/redemptions of units; and custodial related services to hold MF units on behalf of their owners. The intermediary components are coupled for communication between the dealer components 104 and 106; MF order pre-processing component 111; and MFC system 112 but also amongst each other as further described. As depository system 116 holds (i.e. keeps records of ownership, etc) the MF units, it communicates with transfer agent and registrar services system 120 which issues and cancels MF units in response to trade orders from the MF system 112, via MF pre-processing component 111. Depository system 116 further communicates with dealer components (e.g. 104) to obtain and respond to notices of purchase and sale of MF units to match with information from the transfer agent and registrar (component 120) and further flows payment in settlement of same between the dealer and MFC. Settlement agent system 118 performs payment related services for MFC system 112, communicating with depository system 116 and MF pre-processing component 111. Settlement operations are described in further detail below with reference to FIGS. 5A-5E.

It is understood that exchange traded equities (stocks) and ETFs are the type of securities that settle through a depository service such as is available from service providers. In the Canadian market such a service provider includes Canadian Depository for Securities (CDS). Since the purchase and sale of MF units is to be integrated into dealer processes including settlement processes, the components of system 100 that are trading such units in the newly described manner are configured to have the MF units behave much like an equity or ETF. Settlement of trades is through the same one or more depository services used for such equities and ETFs. Processes and services arrangements (e.g. contractual arrangements, accounts, security protocols and identification information, etc.) are implemented to enable such settlements. It is understood that a purchase may be referenced as a subscription for the MF units and a sale may be referenced as a redemption of MF units. MF units may be issued by a registrar for a subscription and cancelled/withdrawn for a redemption.

In an embodiment, CDS may be contracted to provide the depository and settlement services (component 116). A CDS eligible transfer agent and registrar may be assigned to provide component 120. Arrangements may be concluded by the MFC with a CDS-eligible settlement participant to enable the MFC to be counterparty to a trade within CDS. An arrangement with a settlement agent may be concluded to facilitate money movement through depository and settlement services component 116 via component 118. The settlement process includes the set-up of a clearing account at the settlement agent. At the end of each day, this process allows the settlement agent to automatically sweep into the clearing account any MFC surplus/shortfall cash positions within the settlement agent's settlement account. MFC, in turns, wires to/from the clearing account as necessary.

It is understood that exchange traded security OMS 114 represents an existing one or more computing components for the purchase of exchange traded securities well-known to those of ordinary skill in the art and need not be described in detail. It is also understood that trades in securities, including ETFs, made via exchange traded security OMS 114 are completed using intermediary custodial settlement services which services, also communicate (not shown) with the dealer-side components, such as dealer accounting and records system 106. In the present embodiment, at least some of the intermediary custodial settlement services for exchange traded securities are provided by the same providers/components (e.g. 116 and 120) as the intermediary custodial settlement services and components described in relation to the purchase and sale of the non-exchange traded MF units.

Components 102-111 and 116-122 may comprise a channel 124 for ordering and settling non-exchange traded MFs and exchange traded securities including ETFs with respective systems, namely MF system 112 and exchange traded securities OMS 114.

System 100 further shows components of a MF order channel 130, in, accordance with the prior art, for ordering and settling non-exchange traded MFs only. Channel 130 comprises a dealer MF order entry component 132, a MF order management component 134 and a representative third party component 136. Channel 130 communicates with MF system 112. Component 134 may provide transaction placement, file transfers, payment exchange and reconciliation of mutual fund orders. Certain services may be provided by intermediaries using connected components (not shown). In one embodiment, component 134 is provided by FundSERV Inc. Though not shown, orders may be placed in other manners with MF system 112 such as via telephone or facsimile. When orders for MF units are placed via dealer OMS 104 and settled via the intermediary components as described herein, channel 130 need not be used and may be redundant in relation to these MFs. Hence MF system 112 may process and settle orders for both channels 124 and 130. It is further noted that some components such, as third party components may be active in both channels. For example, component 122 of channel 124 may also be active as a third party component 136 in channel 130, providing end of day pricing information within the respective channels.

In accordance with the methods, systems and components disclosed herein there is presented a solution designed to address the challenges in accessing actively managed mutual funds using the dealer's existing equity order management systems and processes.

By creating a new series of MF units for dealers to bulk trade in a single omnibus account leveraging their own in-house systems for client account/record-keeping, settlement and trading, resource usage and other cost savings can be gained through the elimination of the additional/separate layers of Transfer Agency (TA)-related administrative requirements.

Other duplicate costs and computer and environmental resource usage such as statements, mailing costs, registered account setup, client servicing, manual processing, etc. would also be reduced or eliminated and would be reflected in an overall reduction in fund expenses. This also increases operational efficiency at the IA level with ability to make a single transaction that reflects any adjustments across multiple accounts.

To integrate the ordering of MFs into the dealer OMS 104, dealer components are configured to utilize a routing code (e.g. to associate orders for MF units with a market identifier code (MIC)) to direct the MF unit orders to the appropriate external component, such as MF OMS 110 fronting the networked purchase and sale functionality of MF system 112. A market identifier code (MIC), obtained from the ISO 10383 Registration Authority, and/or a security-specific identifier identifies within industry protocols a destination market to trade such MFs without the bid/ask spreads of market pricing. That is, it provides a destination market which utilizes NAV pricing within the dealer components. In previous implementations, the existing routing codes directed orders only to external components for the trade of exchange traded securities at market pricing.

As noted, previously, MF purchases, redemptions and switches were facilitated through a separate channel (e.g. as provided by FundSERV Inc.) on a per client account basis. IAs, particularly those having responsibilities for discretionary accounts, were unable to place a bulk trade order for MFs through FundSERV on behalf of more than one client. Unlike bulk trading that may occur for stock and/or ETF transactions on discretionary accounts via their portfolio management tools. Dealers have not enabled any bulk trading functionality on these tools for mutual funds orders submitted via channel 130. As such, for discretionary clients, if an IA wants to add a mutual fund position via channel 130, they must manually place the order individually from each investor account as opposed to utilizing a PMS tool enabling them to auto assign orders across multiple accounts as dictated by applicable portfolio models.

Some of the current inefficiencies in at least some environments or jurisdictions sought to be addressed include:
a. Investment dealers maintaining a separate OMS specifically for mutual fund transactions.
b. Investment advisors managing two trade entry systems for each of equity trades and mutual fund trades.
c. Investment dealers disclosing client information to fund manufacturers for record keeping and reporting purposes.
d. Investment dealer clients receiving multiple client statements (if not suppressed at fund manufacturer) and may receive tax reporting from multiple fund companies.

In accordance with the teachings in this disclosure, non-exchange traded mutual funds are enabled to be transacted and administered like an exchange traded security i.e. equity or ETF, mimicking the equity trading flow and addressing inefficiencies.

A “market” destination for the MF units is established and integrated (e.g., via MF OMS 110 into the computer system 100. Depository and related services provided to the industry for equities are extended to units traded from this market (e.g. via depository services system 116). Routing rules are established and implemented into dealer OMS 104 in order to direct MF unit orders to the market destination associated with the new MIC using Financial Information eXchange (FIX) protocol messaging.

The MF units from the new market do not trade on a public exchange and, therefore, intra-day pricing is not necessary. But an end of day NAV is calculated on a daily basis such as by MF system 112. The NAV data is then provided in a price file to MF OMS 110 to fill the day's orders as described further below.

In accordance with an embodiment, a price file specific to the MFs traded by this new market is generated by pricing function/component within the MF system at the end of each trading day at around 6 pm. The price file is uploaded (e.g. automatically) to a file transfer protocol (FTP) site where it is retrieved by MF OMS 110 for loading. Other delivery/retrieval mechanisms may be used. Once loading is successful, MF OMS 110 executes a job (operations) to automatically fill open MF unit orders before 7 pm each day, communicating with dealer OMS 104.

To facilitate “late” processing of orders in dealer OMS 104 and dealer order entry component 102, in accordance with an embodiment, dealer OMS 104 [and dealer order entry component 102] may be adapted/configured, such as with a script, to keep the market day typical orders for these MF units open for processing until 7 pm allowing for the fills to occur. It is understood that orders for exchange traded securities are filled and closed using market prices during the trading day or using limited “after market” trading mechanisms. After-market mechanisms are typically manual in nature and completed within 90 minutes or less of market close (e.g. by 5:30 pm).

To integrate MF unit order fulfillment into dealer components, including portfolio management functionality described in relation to dealer order component 102 in FIG. 1, it is useful to timely deliver fill prices for the respective MF units.

Orders through a portfolio management system (e.g. Croesus™, TooGood™) are processed for batching into dealer accounting and records system 106 well after market close and as late as 7 pm. This means that for discretionary orders, dealers are able to receive notification of order fulfillment back from MF OMS 110 between 6:15 pm and 6:55 pm, capture the filled orders from the dealer OMS 104, then, send executed orders to dealers accounting records system 106 for clearing and settlement (e.g. through a batch file process).

In contrast for non-discretionary orders in accordance with previous processes, orders are booked into dealer accounting and records system 106 at market close if orders are filled. This means that open market day orders expire if not filled at time of market close. As orders for MF units in the integrated system 100 using dealer OMS 104 are placed as market day orders and since the NAV will not be ready until after 6 pm, these orders will expire in a dealer's OMS unless it is adapted/configured otherwise. The solution being developed is to batch a file into dealer accounting and records system 106 from dealer OMS 104.

Currently, in the dealer back office systems (e.g. components 106 and 108) security class codes are utilized to define how a security behaves (e.g. how orders are processed for clients, etc.) and clears (e.g. how orders are settled with component 116, etc.). Orders for MF units may be similar processed and cleared by components 106 and 108 such as by configuring security master 108 with applicable data for such orders and mutual funds. In one embodiment, a unique security class code/product classification or type may be defined for the trading of MFs in this channel 124 in a similar manner to an ETF, combining equity and mutual fund attributes so that regulatory compliance requirements are met (e.g. such as the communication to client purchasers of “Fund Facts” documents or other point of sale disclosure documents).

It is understood that security master 108 is a simplification and that there may be various security master platforms within the dealer ordering, order management and back office systems (represented as components 102, 104 and 106) that may each require configuration. Although the MFs of system 112 are not listed on a regulated exchange, in addition to CUSIPS (a nine-character alphanumeric code that identifies a North American financial security for the purposes of facilitating clearing and settlement of trades), ISINs (An International Securities Identification Number (ISIN) uniquely identifies a security comprising a 12-character alpha-numerical code for uniform identification of a security at trading and settlement) and Sedols (a unique identification code consisting of seven alphanumeric characters that is assigned to all securities trading on the London Stock Exchange and on other smaller exchanges in the United Kingdom), a unique identifier may be assigned to each MF to be utilized in the same manner as a Ticker symbol. Dealer components 102-106 may be enriched with this information to assist with trades for the identified MFs. Orders can be routed to a destination (e.g. MF OMS 110 and ultimately MF system 112) utilizing this unique security identifier in a similar/same manner to how a ticker symbol is utilized.

The updating of exchange listed securities in many of these environments is automated and managed via various different feeds of electronic information (not shown). Information for traded MFs within channel 124 may be provided to sources of such feeds to facilitate (automatic) communication to dealer components, etc. in a similar fashion to exchange traded securities such as ETFs.

Dealer OMS and back office service providers may develop a new market destination and/or security class code/product classification identifier specific to MFs traded in channel 124. For example, IVZX is the MIC authorized by the ISO to represent Invesco™ as a market place/destination (e.g. identifying a MF OMS component to which to route orders for processing, etc.). The establishment of this code allows dealers to utilize this as a category under which the securities can be grouped. Like on an exchange the securities can in a sense be listed with IVZX. In some embodiments dealer OMS and back office systems may establish this destination (e.g. IVZX IZX, IZ, etc.) as a market place in order to mimic the set up and format of a regulated exchange. In other embodiments the trades/orders need not be set up and format for routing to a regulated exchange. They may be treated as an over the counter (OTC) instrument within the dealer components but be routed to MF OMS 110.

FIG. 2 is an illustration of a portion 200 of the computer system 100 of FIG. 1, in which MF OMS 110, MF pre-processing component 111 and MF system 112 are shown in more detail and in accordance with one embodiment. FIG. 3 is an illustration of a flow of operations between components of FIG. 2 for order processing on the day of trade (T+0) for the purchase and sale of mutual fund units in accordance with one embodiment. MF OMS 110 is communicating with MF order pre-processing component 111 having utility 204 and database 206. MF system 112 is shown comprising MF trade order processing and record keeping system 208 having a workflow processing component 210 and database 212 and fund accounting system 214. Operations are described further with reference to FIG. 3.

Portion 200 shows dealer OMS 104 coupled for communication with MF OMS 110 which in turn is coupled for communication with MF pre-processing component 111 (e.g. utility 204) and to MF system 112 (e.g. MF accounting system 214). MF pre-processing component 111 (e.g. utility 204) is also coupled to MF system 112 (e.g. MF trade order processing and record keeping system 208). MF trade order processing and record keeping system 208 of MF system 112 is coupled to communicate with previously known MF order management component 134 to receive orders in accordance with prior art. Fund accounting system 214 is coupled to communicate with a representative third party component 136 for example to provide end of day pricing information, in addition to its coupling with MF OMS 110 to also provide end of day pricing information. MF OMS 110 provides orders through component 111 and its utility 204 for pre-processing prior to transfer to MF trade order processing and record keeping system 208 where orders from MF OMS 110 may be processed similarly to orders received from component 134 in the legacy channel 130.

To support the settlement process through the intermediary components rather than through previously used systems of channel 130, utility 204 and database 206 are configured to:

a) store necessary data points—for dealers, trades and settlement operations;

b) integrate into existing mutual fund processes seamlessly for the purposes of record keeping, pricing mechanism and custodial settlement processes;

c) generate required output files in an automated manner to meet strict file dissemination timeline requirements on T+1, Output files include:

i) SWIFT files for settlement;

ii) Treasury Direction Notices for creation/withdrawal of units in the marketplace; and

iii) Dealer Settlement Confirmations.

Utility 204 may be configured with a user interface (not shown) to enter dealer information and preferences. The information is then stored in database 206 (e.g. a SQL Server facility) and later used to drive many of the reporting requirements. Typical information includes, but not limited to:
a Dealer information; e.g. information identifying the dealer such as CUD (e.g. with CDS), dealer number, dealer name;
Dealer Volume Settlement—determines at which level the trades will be aggregated for settlement purposes. For instance, option to either settle individual or aggregated trades at the purchase type level can be made available;
Dealer Settlement option—via depository service (e.g. component 116), Wire or EFT. Depository service is the default;
Dealer's depository service banking information; and
Settlement Agent's banking information.

A link is provided between the utility 204 and existing mutual fund processes, (e.g. workflow processing component 210 and database 212 of MF trade order processing and record keeping system 208), Although dealer preferences are housed within the utility 204 and database 206, key information may be linked to the existing databases (e.g. 212) for the purposes of account setup, which will be later used for transactions processing that triggers downstream activities such as: pricing and fund custodial settlements. Within MFC system 112, MF units are processed in association with the dealer information such that the respective dealers, rather than the clients on whose behalf the orders are placed, are owners of the MF units. In contrast, orders received via channel 130 include client information for individual clients and are processed such that within MFC system 112 the MF units are owned by the individual clients (and not any dealer placing the order).

Communications among the components of FIG. 2 to handle distributions are as follows. In the present embodiment, cash distributions are employed (e.g. in contrast to reinvestments back into the particular MF). An announcement of distributions is made by MFC system 112 (component 208) to transfer agent and registrar services system 120, which in turn notifies depository system 116. Additionally, distribution information is communicated to other systems such as component 122, among others (not shown). Funds, pertaining to the payout amount required for the holders of record for the outstanding shares, are transferred by MFC system 112 to settlement agent 113, who passes this over to depository system 116.

Computer system 100 and portion 200 thereof are simplified to show a single dealer OMS 104, MF OMS 110, MF pre-processing component 111 and MF system 112. It is understood that a mutual fund company may maintain and offer to dealers, etc. more than one different mutual fund and that MF system 112 may process orders, etc. for more than one mutual fund. MF OMS 110 may receive orders for a plurality of different mutual funds and direct such orders to appropriate MF systems (not shown) processing for respective MFs. MF OMS 110 may fulfill orders from a plurality of different dealer OMS systems (not shown). A particular MF system 112 may receive orders from more than one MF OMS (not shown). Orders and/or data associated with same (such as in a batch file, manifest, etc.) may include sufficient identifying information to identify entities or components in the channels of processing to permit the MF OMSs and MF systems to process orders for specific mutual funds at appropriate MF systems and route fulfillment and other messages to appropriate MF OMSs and dealer OMSs from which the respective orders were received. Similarly for orders received by a MF system from channel 130 via MF order management component 134, such orders are distinguishable to enable the MF system to fulfill such orders back through channel 130 to ordering component 132.

Flow 302:

With reference too then to FIG. 3 which shows a flow 300 of communications/operations for order fulfillment among the components of FIG. 2, IAs may place orders for MF units which are then routed by dealer OMS 104 to MF OMS 110. The orders are assigned a time of receipt timestamp by MF OMS 110. Those received by market close are processed for the current days NAV. Those received afterward may be processed on a next market day (i.e. for a next market day NAV). Dealer orders communicated to MF OMS 110 do not include the dealer's client information (i.e. individual retail investor information). Rather, dealer information the sole identifier for processing entries by MF system 112. In contrast, orders provided via component 134 include individual retail investor information. Within channel 130, the MFC is responsible for tax reporting directly to the individual client investor (not shown). This processing etc. is onerous and consumes significant resources particularly as many individual funds are owned by many individual clients. When MFs are purchased through channel 124, the MF is associated with a Dealer and/or IA and not the individual client. The MFC is not responsible for tax reporting directly to the investor. Similar reporting processes (not shown) such as those associated with ETFs may be used within this new channel 124, significantly reducing the processing and resource burden of an MFC (including MFC System 112).

Flow 304:

In accordance with one embodiment, between 4 pm and 7 pm and MF OMS 110 transmits various files with the list of orders and dealer details to MF order pre-processing component 111 such as by FTP. The first order file at about 4 pm contains all orders up to that time, which are ingested and stored (e.g. via utility/database 204/206) for processing. It is understood that the time listed herein represent typical activity times following a regular close of markets at 4 pm eastern time. Timing may be adjusted to local time and applicable market close time.

Flow 306:

Once all orders are received, the next objective is to load the orders into the MF trade order processing and record keeping system 208. To accomplish this, a Trade Processing file (not shown) is created from the utility 204, listing valid orders grouped and aggregated by fund, account, dealer and their volume settlement preferences (as described with reference to settlement below). In one example the Trade Processing file is produced at about 4:30 pm and sent electronically into MF trade order processing and record keeping system 208 (i.e. workflow processing component 210 and database 212). This operation ensures that all MF unit orders are integrated into the record keeping system 208 so that they can be included in further processing (e.g. overnight cycle jobs).

For completeness in accordance with this embodiment, a second order file is received at about 7 pm from the MF OMS 110, containing all orders for the day (including prices) stamped as received by MF OMS 110 and any orders received by MF OMS 110 before 4 pm but due to processing/system issues may have not have come through in the first file documented in flow 304. Both files are processed and stored in the utility 204 for processing (i.e. flows 304 and 306 are repeated).

Once the orders are processed and integrated into the MF trade order processing and record keeping system 208, normal mutual fund activities are leveraged, including pricing, accounting and custodial settlement processes, which may be adapted to direct custodial settlement and banking messages to appropriate external parties as described.

Flow 308:

At the end of the day, NAV prices are struck by fund accounting system 214 and delivered to various destinations, including: MF order processing record keeping system 208, and various third parties such as various industry media outlets and fund/ETF data aggregators. For MF trades received through legacy channels (e.g. 130), the NAV prices are ingested by MF order processing record keeping system 208 as part of the nightly batch cycle as per normal process. The NAV prices for orders placed through MF OMS 110 are present in the 7 pm order file as described below.

Flows 310 and 312:

For orders received via MF OMS 110 prices are reported back to dealer OMS 104 as follows. Accounting system 214 reports prices via a price file to MF OMS 110 and MF OMS 110 reports the filled orders with prices back to the dealers OMS 104 which is then integrated into their nightly settlement processes (not shown). OMS 104 may provide such order filling information and prices to dealer order entry component 102. Once the price file is received by the MF OMS 110, a price file acknowledgement communication (e.g. an email) is sent back to the MFC.

In one embodiment, to accommodate strict timelines for price delivery within dealer OMS 104 to ensure inclusion in settlement processes in the dealer components, a polling job is configured within MF OMS 110 to search for a price file running as late as 6:35 pm and 6:55 pm. A communication (e.g. an email) is sent to the MFC if the job is unable to find a price file.

Though not shown in the Flow 300, orders for MF units may also be received by telephone or facsimile before 4 pm for overnight processing to receive the current order day's NAV pricing. These communication channels may be maintained as alternative or redundant channels such as for emergencies.

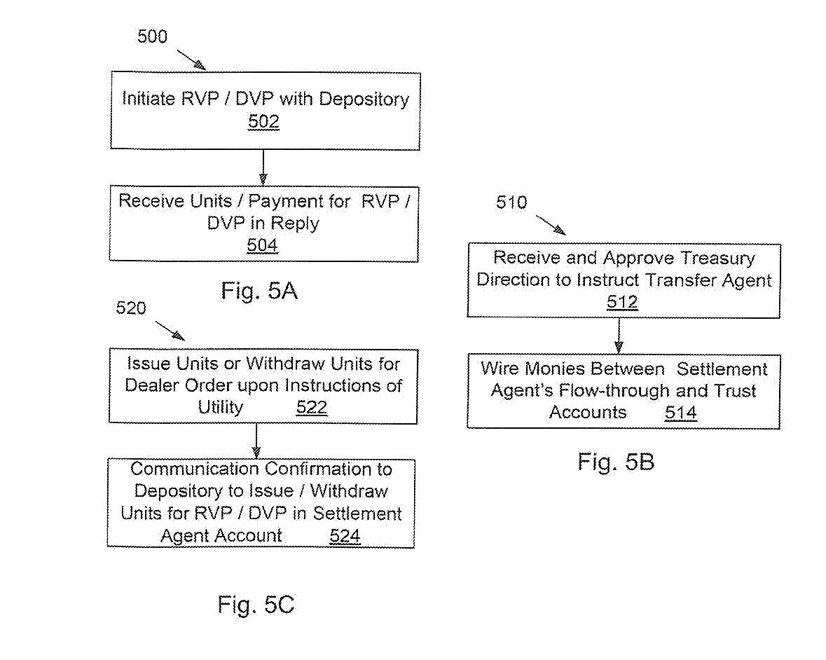

FIGS. 4A-4B and 5A-5E are flowcharts for operations of certain components of the computer system of FIGS. 1 and 2 in furtherance of the settlement of orders for mutual fund units in accordance with one embodiment.

FIGS. 4A-4B show respective operations 400 and 420 of MF order processing and record system 208 and utility 204 (of MF pre-processing component 111). These processing operations are typically performed on the day following the trade date (T+1) to provide timely release of all output files for settlement where, in accordance with certain protocols, settlement must be concluded by T+3.

The MF order processing and record keeping system 208 performs normal order processing operations (typically overnight) for the orders of the previous business day including orders via channel 130 (at 402) and maintains records therefor including client accounts.

Utility 204 reintegrates the processed orders that were previously received via MF OMS 110. Within the utility 204, a job (computer operations) is deployed to populate internal systems with these ‘processed’ records (at 422). The job also performs validation checkpoints. This step ensures that not only are correct transaction types imported, but the units, prices and dollars reflected in the record keeping system (i.e. MF's official books and records) are used as a source for all output for: (1) the issuance and withdrawal of units at the transfer agent and registrar (component 120); (2) settlement via components 118 and 118; and (3) dealer trade confirmation (to component 104).

Next (at 424), utility 204 produces internal reports for reconciliation and validation. The following are typical validation points:
a) Orders per MF OMS 110=Trades processed in MF record keeping system 208;
b) NAV Prices in MF OMS 110=NAV Prices processed in MF record keeping system 208; and
c) All MF OMS 110 trades processed and pertinent data points are accurately reflected in all output files described below (in step 428).

Reconciliation reports and transactions may be presented (at 426) via an interactive user interface (e.g. via a display screen (not shown)) and user inputs received for corrections and/or error confirmation. User input may be received which verifies and signs-off and submits the completion of the review prior to the dissemination of output files.

With strict timeline requirements for file exchange within the equity universe, all parties must match and, confirm T+3 settlements by mid-day on T+1. In one embodiment, flexibility through an interface provides users with the ability, to update incorrect transactions, adjust settlement dates as necessary, as well as append new correct records without the usual wait that typically comes with corrections cycling through the evening of T+1. This functionality effectively bypasses the delays and thereby eliminates the need to recall or manually fix incorrect output that could result in undesired breaches. With this feature, whenever an error is detected through the review process, the user is able to make real-time corrections online and re-launch the Output job described below. This feature permits all output to be generated with accurate information in one step.

Completion of the review (“submit”) notifies/invokes the utility 204 to trigger the Output job (within utility 204) to compile all information necessary and produce the following output files (at 428) for communication to the respective intermediary component:
1. Treasury notices for transfer agent and registrar 120 and related advice notices confirming this information to settlement agent system 118 for the purposes of Creation/Cancellation of units in the marketplace.
2. Payment messages for settlement. The payment messages act as instructions from MFC system 112 to authorize the money movement processes between a clearing account at settlement agent system 118 and the settlement agent's settlement accounts at depository service system 116, as further described below. In one embodiment the payment messages are in accordance with Society for Worldwide Interbank Financial Telecommunication (SWIFT) standards.
3. Dealer Trade Settlement Confirms. The format was developed to mimic information confirming ETF trades the dealers typically receive.

These various files may be communicated in accordance with various protocols and requirements set and/or agreed amongst the service providers as to format, timing, security and other manners of delivery. For example, with reference to operations 440 of FIG. 40, in one embodiment the operations of step 428 are expanded, Utility 204 generates a treasury direction file (at 442) and communicates same to MFC system 112 for approval (444). At 446, approval is received and at 448, the treasury direction file is communicated to registrar (component 120) and to component 118.

Once all SWIFT messages have been released, the system locks down the appropriate trades for control requirements (at 430).

With reference to FIGS. 5A-5E are flowcharts for operations of certain components of the computer system of FIGS. 1 and 2 in furtherance of the settlement of orders for mutual fund units in accordance with one embodiment. In accordance with industry requirements related to timing of completion of settlement, the operations complete within 3 days of the trade (i.e. T+3).

FIG. 5A shows operations 500 of dealer accounting and records system 106. At 502, dealer initiates a “receive versus payment” (RVP) or “deliver versus payment” DVP in accordance with the type of order (RVP for a purchase and DVP for a sale/redemption) of the MF units. In reply (following processing by the other components as describe below) dealer receives confirmation of the transfer of units and payment made or received in accordance with the RVP and DVP.

FIG. 5B shows operations 510 of MF system 112. At 512, the treasury direction file is received and approved, as applicable, to utility 204 so that transfer agent and registrar (component 120) is instructed to issue or withdraw/cancel units in accordance with the dealer's order processed by the MF system as described with reference to FIG. 4B at 428 and FIG. 40. Notification of same is communicated to settlement agent 118 also discussed above with reference to the utility 204.

At 514, MF system 112 (component 208) wires monies between a clearing account at settlement agent and a MFC trust account. End of day balance in clearing account is zero.

FIG. 5C shows operations 520 of transfer agent and registrar system 120. At 522 Units are issued or withdrawn for the dealer order upon instructions of utility 204 (as confirmed by MF System 112). At 524 transfer agent and registrar system 120 communicates a confirmation to depository system 116 to issue/withdraw units for RVP/DVP in settlement agent's account maintained by the depository system 116.

FIG. 5D shows operations 530 of depository system 116. At 532 the dealer's instructions are received to setup RVP/DVP against settlement agent account and acted upon. At 534 communications with settlement agent are performed to settle RVP or DVP. At 536 the transfer agent's confirmation communication in respect of the creation or cancellation of shares relative to the settlement agent are received. At 538 units are issued or withdrawn in settlement agent account.

FIG. 5E shows operations 540 of settlement agent 118. At 542, operations receive a notification communication from utility 204 for the issue or withdrawal of MF units.

At 544 instructions are received from utility 204 to match RVP or DVP trade at the depository services system 116 and at 546 communications are made with the depository services system 116 to settle the RVP or DVP.

At 548, money is wired to/from MFC clearing account.

As will be apparent to those of skill in the art upon reading this disclosure, many of the individual embodiments described and illustrated herein has discrete components and features which may be readily separated from or combined with the features of any of the other several embodiments without departing from the scope or spirit of the present teachings. Any recited method can be carried out in the order of events recited or in any other order which is logically possible.

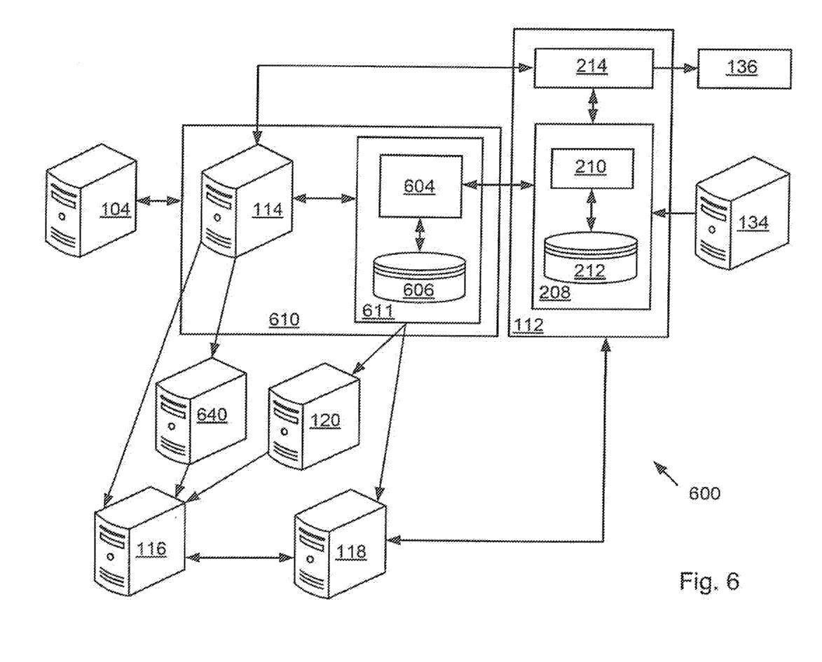

For example, FIG. 6 illustrates an embodiment 600 which is similar to the embodiment of FIG. 2 but where OMS component 610 incorporates exchange traded security OMS 114 and incorporates features of MF OMS component 110 to perform similar operations to component 110. OMS component 610 has configured therein MF order pre-processing component 611 having utility 604 and database 606, performing comparably to MF order pre-processing component 111, utility 204 and database 206, respectively.

It is understood that dealer OMS 104 is configured to communicate orders with the appropriate destination—i.e. to an exchange type platform identified by an appropriate market or routing code for component 610.

In the context of processing MF orders from a dealer OMS 104, component 114 is not utilized to its full extent, for example, in its capacity as a regulated exchange. Rather, the MFs may be listed within component 114 as a quasi-listing to leverage off the communication and processing environment and security master. Orders are reported from OMS 610 (e.g. utility 604) to MFC system 112 and its MF trade order processing and record keeping system 208 for order fulfillment processing similarly to that previously described and as further described below.

In the embodiment shown in FIG. 6, the dealer OMS 104 faces off with an Exchange (i.e. exchange traded security OMS 114) instead of an MFC via an MFC OMS 110. A trade execution counterparty broker component 640 is shown in FIG. 6 between component 114 and a settlement agent component 118. In the model of the present embodiment, component 610 treats transactions like listed exchange executed securities and thus creates a ‘street’ trade. In contrast, the model of the embodiment depicted and described with reference to FIG. 2 shows the MFC facing off to the Dealer directly and settling trade for trade (TFT) with the settlement agent 118. In the new model of FIG. 6, the Trade Execution Counterparty Broker would assume the role of the MFCs representative to the market.

MF order processing at component 610 is managed through existing processes used at an Exchange that handles listed securities. In the present embodiment, such MF orders may be handled with fill reporting similar to an “Oddlot” execution process whereby orders are held throughout the trading hours and filled against the Trade Execution Counterparty Broker at the end of the day. This Oddlot process is in contrast to routine orders for exchange traded securities whereby are two parties that place market orders (buy and sell), which are then matched and filled at the market price. In the present case of MF orders, only one party is placing an order and the other party (Trade Execution Counterparty Broker) is just being told what is done on their account without any order being sent. This may be likened to a market maker for the security where the fill is simply routed to them from the exchange (i.e. the Oddlot process). To handle NAV pricing, the market price is not received/applied until NAV is computed as described above, typically about 6:30/7 pm.

Component 610 may provide order files to MFC system 112 at regular intervals throughout the day for e.g. 12 pm, 2 pm, 4 pm cumulative, plus a final EOD report (which can be anytime after 4 pm). In the embodiment of FIG. 2, order files are provided at two times after market close (e.g. approx. at 4:30 and a post 7 pm). Report times can vary and be changed in both models.

Component 610 will also provide a final fill report. A similar report is sent from component 110 in FIG. 2).

In terms of distributions in the embodiment of FIG. 6, communications are as follows. Announcements of distributions are made by MF system 112 (e.g. component 208) to transfer agent and registrar services system 120. As well component 610 (e.g. component 114) may communicate to the market via Bulletins as is standard practice for listed securities.

Additionally, distribution information is communicated to other systems such as component 122, among others (not shown). Funds, pertaining to the payout amount required for the holders of record for the outstanding shares, are transferred by MFC system 112 to settlement agent 118, who passes this over to depository system 116.

In addition and as noted, OMS component 610 and component 114 therein may be configured to process orders for securities and/or ETFs but the details thereof are not shown and described.

The foregoing description has been presented for purposes of illustration and description. It is not intended to be exhaustive or to limit the teachings to the precise form disclosed. Other modifications and variations may be possible in light of the above teachings. The embodiments were chosen and described in order to best explain the principles and their practical application, and to thereby enable others skilled in the art to best utilize them in various embodiments and various modifications as are suited to the particular use contemplated. The scope of the claims should not be limited by the embodiments set forth in the examples, but should be given the broadest interpretation consistent with the description as a whole.

What is claimed is:

1. A method of processing orders for non-exchange traded mutual funds within a computer implemented order management system (OMS) of a dealer, the method comprising:
receiving a mutual fund (MF) units order for a non-exchange traded MF at a dealer OMS where the dealer OMS is further configured to process orders for exchange traded securities including exchange traded funds (ETFs) at intra-day market prices;
routing the order by the dealer OMS to an applicable MF OMS configured to fulfill the order, the order comprising a routing code identifying the applicable MF OMS with which to route the order;
maintaining the order within the dealer OMS after a close of market to await fulfillment of the order at a net asset value (NAV) unit price determined for the non-exchange traded MF after the close of market; and
receiving at the dealer OMS fulfillment of the order from the MF OMS at the NAV unit price.

2. The method of claim 1 comprising settling payment for the order electronically via a computing component of custodial settlement service system, the custodial settlement service system further configured to settle payment far exchange traded securities including ETFs.

3. The method of claim 2 comprising communicating a Receive Versus Payment (RVP) message for the order comprising a purchase of MF units or communicating a Delivery Versus Payment (DVP) for the order comprising a redemption of MF units.

4. The method of claim 1 wherein the order comprises one of:
a discretionary client order associated with a client of the dealer having given a discretionary power to the dealer to make trades for the client at the dealers discretion; and
a non-discretionary order associated with a client of the dealer requiring the dealer to obtain the client's confirmation for trades made for the client.

5. The method of claim 1 comprising communicating order fulfillment to a computing component of a dealer account system maintaining accounts for clients of the dealer, the computing component further configured to maintain client account information in relation to exchange traded securities including ETFs and non-exchange traded MFs traded by the client.

6. The method of claim 1 comprising receiving the order at the dealer OMS from an order entry computer system of the dealer, the order entry computer system configured to communicate orders for exchange traded securities including ETFs and non-exchange traded MFs, the order entry system associating each order with a respective routing code with which to route the order for fulfillment.

7. The method of claim 6 wherein the order entry computer system is configured to communicate orders comprising at least one of a discretionary client order associated with a client of the dealer having given a discretionary power to the dealer to make trades for the client at the dealer's discretion; and a non-discretionary order associated with a client of the dealer requiring the dealer to obtain the client's confirmation for trades made for the client.

8. A computer component to process orders for non-exchange traded mutual funds by a computer implemented dealer order management system (OMS) of a dealer, the computer component comprising at least one programmable processor and a storage device storing instructions and data which when executed by the at least one programmable processor configure the computer component to:
receive a mutual fund (MF) units order for a non-exchange traded MF at the dealer OMS where the dealer OMS is further configured to process orders for exchange traded securities including exchange traded funds (ETFs) at intra-day market prices;
route the order to an applicable MF OMS configured to fulfill the order, the order comprising a routing code identifying the applicable MF OMS with which to route the order;
maintain the order within the dealer OMS past a close of market to await fulfillment of the order at a net asset value (NAV) price determined for the non-exchange traded MF after the close of market; and
receive fulfillment of the order from the MF OMS at the NAV price.

9. A method to process orders of mutual fund (MF) units for a non-exchange traded MF within a computer implemented order management system (OMS) of a MF, the method comprising:
receiving, from a dealer OMS at a computing component of a MF OMS, a plurality of mutual fund (MF) units orders for at least one non-exchange traded MF;
maintaining the plurality of orders within the MF OMS after a close of market to await determination of applicable net asset value (NAV) unit prices determined for each of the at least one non-exchange traded MF after the close of market;
communicating a first batch of the plurality of orders to a MF system configured to process the orders for fulfillment at the applicable NAV unit prices;
receiving the applicable NAV unit prices after close of market from the MF system;
associating the applicable NAV unit prices with each respective order of the plurality of orders; and
communicating a second batch of the plurality of orders to the MF system to process the orders for fulfillment, the second batch of the plurality of orders including the applicable NAV unit prices.

10. The method of claim 9 comprising communicating fulfillment of the order at the NAV unit price to the dealer OMS.

11. The method of claim 10 wherein each order is associated with a time of receipt timestamp by the MF OMS to determine which orders receive a current day NAV unit price by the MF system when the orders are received before a close of market time and which orders receive a next day NAV unit price.

12. The method of claim 9 wherein the dealer OMS is further configured to process orders for exchange traded securities including exchange traded funds (ETFs) at intra-day market prices.

13. A computer component to process orders for non-exchange traded mutual funds by a computer implemented mutual fund (MF) order management system (OMS), the computer component comprising at least one programmable processor and a storage device storing instructions and data which when executed by the at least one programmable processor configure the computer component to:
receive, from a dealer OMS at a computing component of a MF OMS, a plurality of mutual fund (MF) units orders for at least one non-exchange traded MF;
maintain the plurality of orders within the MF OMS after a close of market to await determination of applicable net asset value (NAV) unit prices determined for each of the at least one non-exchange traded MF after the close of market;
communicate a first batch of the plurality of orders to a MF system configured to process the orders for fulfillment at the applicable NAV unit prices;
receive the applicable NAV unit prices after close of market from the MF system;
associate the applicable NAV unit prices with each respective order of the plurality of orders; and
communicate a second batch of the plurality of orders to the MF system to process the orders for fulfillment, the second batch of the plurality of orders including the applicable NAV unit prices

14. A method to process orders for mutual fund (MF) units for a non-exchange traded MF by a computer implemented MF system comprising at least one computer component configured to process MF orders, maintain records and perform fund accounting for at least one non-exchange traded MF, the method comprising:
receiving first orders for MF units of at least one non-exchange traded MF from a first channel comprising computing components configured to trade and settle exchange traded securities and non-exchange traded MFs;
receiving second orders for MF units of at least one non-exchange traded MF from a second channel comprising computing components configured to trade and settle only non-exchange traded MFs;
processing the first orders and second orders at respective net asset value (NAV) unit prices determined after a close of market for each of the at least one non-exchange traded MF; and
communicating the respective NAV unit prices back to the first channel and second channel.

15. The method of claim 14 further comprising settling payment of at least some of the first orders via the first channel and settling payment of at least some the second orders via the second channel.

16. The method of claim 15 comprising maintaining information and preferences for respective dealers to configure steps of processing and settling in respect of first orders received via the first channel from the respective dealers.

17. The method of claim 15 further comprising communicating with a transfer agent and registrar system of the first channel to issue or cancel MF units in accordance with the first orders as processed, wherein the transfer agent and registrar system is configured to communicate issuances and cancellations of MF units in accordance with the first orders as processed with a depository system of the first channel providing custodial settlement services.

18. The method of claim 17 comprising communicating payment and processed order communications with the first channel to settle payment for the first orders through the depository system and in accordance the issuances and cancellations of MF units by the transfer agent and registrar system.

19. The method of claim 18 wherein the payment and processed order communications are communicated with a settlement agent system having an account with the depository system, the settlement agent concluding settlement on behalf of the MF system in accordance the issuances and cancellations of MF units by the transfer agent and registrar system.

20. The method of claim 14 comprising:
preparing reconciliation reports from transaction records prepared during the processing of the first orders as processed;
presenting the reconciliation reports and transaction records for verification of accuracy; and,
presenting a user interface to receive input to review and correct the transaction records.

21. The method of claim 20 further comprising settling payment of at least some of the first orders via the first channel including generating one or more output files for communication via the first channel in furtherance of settlement using the records as corrected.

22. The method of claim 14 wherein the first orders are received from at least one MF order management system (OMS) configured to receive orders for non-exchange traded MF units within the first channel; wherein the first orders are received with a time of receipt timestamp associated by the at least one MF OMS; and wherein the first orders are processed by the MF system to receive a current day's NAV unit price if received before market close in accordance with the timestamp.

23. The method of claim 22 wherein receiving the first orders comprises:
receiving a first batch file of first orders after market close from each of the at least one MF OMS, the first orders received before association with a NAV unit price by the at least one MF OMS; and,
subsequent to the communicating of the respective NAV unit prices back to the first channel to deliver the NAV units prices to the at least one MF OMS, receiving a second batch file that includes the first orders of the first batch file, wherein the first orders are associated with the respective NAV unit prices by the at least one MF OMS.

24. The method of claim 23 wherein the step of processing the first orders at NAV unit prices comprises using the NAV unit prices as received in the second batch file.

25. The method of claim 14 comprising pre-processing the first orders to load the first orders into a computing component of a order processing and record system to process the first orders with the second orders to leverage operations of the order processing and record system for orders received from both of the first and second channels.

26. The method of claim 14 wherein each of the first orders are placed by dealers on behalf of clients of the dealers and each of the first orders include only dealer information to process the first orders, such that the respective MF units of the first orders are processed as owned by the respective dealers and wherein each of the second orders include client information for individual clients to process the second orders, such that the respective MF units of the second orders are processed as owned by the respective individual clients.

27. A computer implemented MF system comprising at least one computer component configured to process orders for mutual fund (MF) units for a non-exchange traded MF, the computer component comprising at least one programmable processor and a storage device storing instructions and data which when executed by the at least one programmable processor configure the computer component to:
receive first orders for MF units of at least one non-exchange traded MF from a first channel comprising computing components configured to trade and settle exchange traded securities and non-exchange traded MFs;
receive second orders for MF units of at least one non-exchange traded MF from a second channel comprising computing components configured to trade and settle only non-exchange traded MFs;
process the first orders and second orders at respective net asset value (NAV) unit prices determined after a close of market for each of the at least one non-exchange traded MF;
communicate the respective NAV unit prices back to the first channel and second channel; and
settle payment of at least some of the first orders via the first channel and settling payment of at least some the second orders via the second channel.
